(19) United States
(12) Patent Application Publication
(10) Pub. No.: US 2009/0078483 A1
(43) Pub. Date: Mar. 26, 2009

(54) BATTERY POWERED FLOOR CONVEYOR

(75) Inventors: Hartwig Grothkopp, Hamburg (DE); Andreas Knie, Hamburg (DE); Ernst-Peter Magens, Ammersbek (DE); Frank Maenken, Henstedt-Ulzburg (DE); Christoph Weber, Henstedt-Ulzburg (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Jungheinrich Aktiengesellschaft, Hamburg (DE)

(21) Appl. No.: 12/211,552

(22) Filed: Sep. 16, 2008

(30) Foreign Application Priority Data
Sep. 22, 2007 (DE) 10 2007 045 435.1

(51) Int. Cl. B60R 16/04

(52) U.S. Cl. 180/68.5

(57) ABSTRACT

A battery powered floor conveyor, characterised in that two or more individual battery cells of a maintenance-free battery are integrated in existing cavities or other badly accessible locations of the floor conveyor in a not or only difficultly removable or not exchangeable fashion, respectively, wherein at least one battery cell is built in inside a wheel arm, below a standing platform or into a lifting scaffold.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

As is generally known, batteries are the energy sources of electric floor conveyors. Lead-acid batteries are used by default. Realizations have also become known in which two such batteries are arranged in the floor conveyor. The lead-acid batteries are accommodated in so-called battery boxes, which are arranged at suitable locations in the floor conveyor, so that they can be accessed for exchange without further troubles. In so-called reach mast trucks, the battery box is arranged between the load portion and the shiftable lifting scaffold. In other floor conveyors, the battery box is inserted laterally into a corresponding recess in the housing of the drive- or load portion. Embodiments are also known in which the battery box can be taken out towards the upside after having folded up a cover-up flap first. Altogether, it can be stated that the constructional concept of a floor conveyor is strongly depending on the dimensions of the battery, because the same occupies a relatively large volume of the vehicle.

Charging lead-acid batteries takes normally several hours, so that in a multi-shift working mode of the floor conveyor, an exchange of the battery for charging it has to be performed. For this reason, as already mentioned, the battery is arranged at easily accessible locations in the floor conveyor.

In a floor conveyor, its maneuverability is a decisive feature. The same is essentially determined by the so-called L2-dimension, the distance between the vehicle front side and the fork back. In many floor conveyors, the L2-dimension is increased about the width of the battery box.

The present invention is based on the objective to provide a battery powered floor conveyor, whose length dimension is not at all or only unessentially influenced by the battery.

### BRIEF SUMMARY OF THE INVENTION

In the battery powered floor conveyor of the present invention, two or more individual battery cells (38, 40) of a maintenance-free battery are integrated in existing cavities or other badly accessible locations of the floor conveyor in a not or difficultly removable or not exchangeable fashion, respectively, wherein at least one battery cell is built in inside a wheel arm, below a standing platform or into a lifting scaffold.

The present invention starts from the awareness that new battery technologies are available, which feature advantages over conventional lead-acid batteries with respect to dimension, weight, fast charging capability and lifetime. In addition, they have the advantage to be maintenance-free. Therefore, they can be accommodated in not or difficultly accessible locations in the floor conveyor. Decisive is only that they have accessible contacts for a charging cable, via which they are charged without being removed from the vehicle. In addition, contacts are provided as surfaces to the entire vehicle electronics.

Batteries of the kind in question permit also the subdivision into plural or arbitrary battery cells, which can be placed at different locations on the floor conveyor. It is only decisive that in combination, they provide the required rated current for operating the floor conveyor.

Changing the battery is not necessary in the present invention. The battery remains always at the location where it is built in, even in the charging procedure. Advantageous embodiments of the present invention are indicated in subclaims.

According to one embodiment of the present invention, it is provided that the battery cells are built in at different locations which are remote from each other. In this way, suitable cavities, which are existing in a floor conveyor of conventional construction, can be used for accommodating one or plural battery cells. For instance, at least one battery cell can be arranged inside the case of the drive portion.

In another embodiment of the present invention, at least one battery cell is built in into a wheel arm case in a reach mast truck, which has relatively plenty of space for accommodating a maintenance-free battery. For the rest, the maintenance-free batteries have the advantage that they are not necessarily bound to preset geometrical dimensions, but can be freely designed in their contour for doing so. As a consequence, such batteries can be adapted to the location where they are to be built in, and it is not necessary, as conventionally required, to provide a suitable location of installation with preset dimensions.

One location of installation according to the present invention is below a standing platform or below a driver seat of the floor conveyor.

In the present invention, at least one battery cell can be built in a lifting scaffold. According to a further embodiment, it can be built in the fixed portion of the lifting scaffold, which is connected to the chassis of the drive portion. Alternatively or in addition, at least one battery cell can be built in the movable part of the lifting scaffold. Here, any arrangement and design of a load portion of a floor conveyor is to be understood as a lifting scaffold, on which a load carrying means is installed or height-adjustably mounted, respectively. In high lift vehicles, there is little installation space for battery cells, as the case may be. Here, an addition to or building in into a fork carrier comes also in consideration, for instance. In low lift vehicles, a load frame is liftable together with the load carrying means about a small height. In high lift floor conveyors, a lifting scaffold consisting of one or plural masts is provided, wherein one load fork is height-adjustably mounted on the respective inner mast, and the telescopable masts are guided and held in one standing mast. In an arbitrary execution of the lifting scaffold kinds, battery cells can be built in anywhere where there is sufficient space and the view-through—in high lift scaffolds—is not affected.

In one embodiment of the present invention, the lifting scaffold is a load frame, which is adjustable in its height with the aid of a lifting drive in the drive portion (free lift). At least one battery cell is built in the load frame. Preferably, a row of battery cells is built in the lower portion of the load frame.

As already mentioned, the battery is maintenance-free in the present invention, and therefore it has not to be removed and/or serviced during the usual working life of the floor conveyor. Because the batteries are fast charging batteries, only small charging times are required in order to recharge empty batteries. Even the weight of such maintenance-free batteries is significantly reduced compared with conventional lead-acid batteries, so that their arrangement in the lifting scaffold, on the movable portion in particular, does not encompass any problems.

Preferably, lithium batteries are suited as the batteries in the present invention. However, other maintenance-free batteries can also be used advantageously.

### BRIEF DESCRIPTION OF THE DRAWING OF THE INVENTION

The present invention is explained in more detail by means of one drawing in the following.

FIG. 1 schematically shows a perspective view of a low lift floor conveyor of the present invention in a schematic representation.

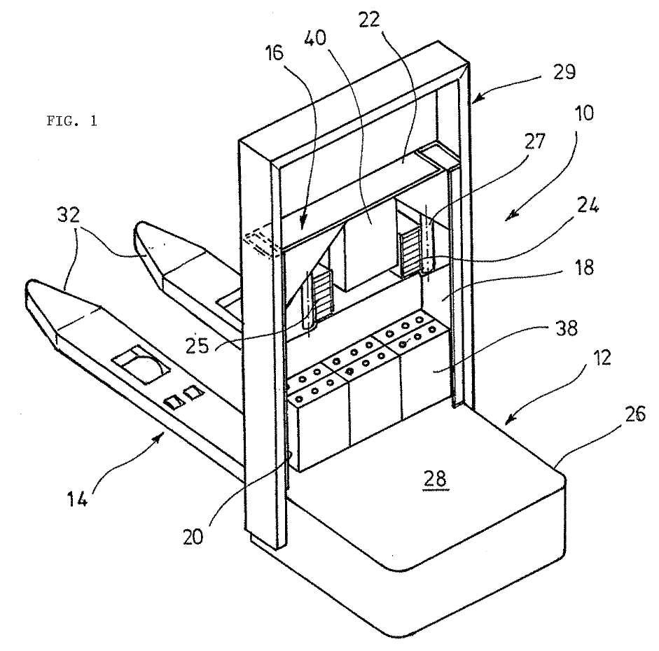

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

In the FIGURE, a low lift truck 10 is depicted, with a drive portion 12 and a load portion 14. The load portion 14 has a rectangular load frame 16 with lateral supports 18, 20 and an upper connection brace 22. The drive portion 12 has at least one steerable driving wheel (not visible), as well as a housing 26, which accommodates driving and steering aggregates (not shown). The upper side forms a standing platform 28 for a driver in the rider operation. He/she can find hold on two parallel armrests, in which can be accommodated operational controls for the actuation of the floor conveyor 10 also (not shown).

A load fork is fixedly connected to the load frame 16, which is indicated at 32. Frame 16 and load fork 32 can be lifted about a so-called free lift by two parallel arranged electric lifting devices. The electric actuators 24, 25 are fixed on a not shown wall of the drive portion, and their spindle 27 engages on the connection brace 22. A mast 29 put over the load frame, which is fixed on the driving portion 16, holds U-profiles on its inner side 31, 33 for guiding the load frame 16. A coupling bar arrangement between the load frame 16 and the drive portion 12 provides that wheels, which are mounted in the fork arms, are moved towards the downside. Such a coupling mechanism is also known, and therefore it will not be described in more detail.

As can be further recognised in the FIGURE, two rows of three battery cells 38 at a time are arranged in the lower region of the load frame 16. A further battery cell 40 is arranged in the upper region of the load frame 16 and attached to the connection brace. The seven battery cells in series supply the necessary rated voltage of the vehicle for operating the floor conveyor 10 in the known manner. For instance, the battery cells are lithium cells, which are marked by a relatively low weight, freeness of maintenance, long life and fast charging capability.

Of course, it is conceivable to arrange all the battery cells 38, 40 or a part of them on the front side between the load frame 16 and the chassis of the drive portion 12, instead of the arrangement of the same in the load frame 16. In this case, they are not lifted together with the load frame 16 when the same is lifted, which is the case in the shown embodiment.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A battery powered floor conveyor, characterised in that two or more individual battery cells (38, 40) of a maintenance-free battery are integrated in existing cavities or other badly accessible locations of the floor conveyor in a not or only difficultly removable or not exchangeable fashion, respectively, wherein at least one battery cell is built in inside a wheel arm, below a standing platform or into a lifting scaffold (16).

2. A floor conveyor according to claim 1, characterised in that the battery cells (38) are built in at different locations which are remote from each other.

3. A floor conveyor according to claim 1, characterised in that at least one battery cell is arranged inside the case of the drive portion.

4. A floor conveyor according to claim 1, characterised in that at least one battery cell is arranged below a driver seat.

5. A floor conveyor according to claim 1, characterised in that at least one battery cell is arranged in a part of the lifting scaffold which is fixedly connected to the chassis of the drive portion.

6. A floor conveyor according to claim 1, characterised in that at least one battery cell is built in into a movable part of the lifting scaffold.

7. A floor conveyor according to claim 1, characterised in that at least one battery cell is added to the chassis of the drive portion (12) at the rear side of the lifting scaffold (16).

8. A floor conveyor according to claim 1, characterised in that all battery cells (38, 40) are built in into the lifting scaffold (16).

9. A floor conveyor according to claim 1, characterised in that in a low lift truck (10), the lifting scaffold has a load frame (16) movable in the height, and at least one battery cell (38, 40) is built in or on the load frame (16).

10. A floor conveyor according to claim 9, characterised in that a row of battery cells (38) is built in the lower portion of the load frame (16).

11. A floor conveyor according to claim 1, characterised in that at least one battery is added to or built in the counterweight in a counterweight stacker.

12. A floor conveyor according to claim 1, characterised in that lithium cells are provided as battery cells.
